(19) United States
(12) Patent Application Publication
(10) Pub. No.: US 2009/0096733 A1
(43) Pub. Date: Apr. 16, 2009

(54) LIQUID CRYSTAL DISPLAY DEVICE

(75) Inventors: Yuya Sato, Mobara (JP); Ikuko Mori, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/248,937

(22) Filed: Oct. 10, 2008

(30) Foreign Application Priority Data
Oct. 11, 2007 (JP) 2007-265387

(51) Int. Cl. G09G 3/36

(52) U.S. Cl. 345/88

(57) ABSTRACT

(Object) To prevent the chromaticity from changing due to the gradation in a display system for improving the blurring in an animated image where one frame is formed of two fields having different brightness.

(Means for Achieving Object) According to a driving method for improving the properties of an animated image by dividing one frame into a bright field having high brightness and a dark field having low brightness where an image is displayed in the case where the gradation of the image is 190 or greater, a change in the chromaticity is great in the dark field. In order to solve this problem, the gradation properties for blue are corrected only in the dark field. The gradation properties of one color which is greatly effective on the chromaticity are changed only for the necessary gradation, and therefore, the chromaticity properties can be improved while preventing the gradation-brightness properties from being affected.

The present application claims priority over Japanese Application JP2007-265387 filed on Oct. 11, 2007, the content of which is hereby incorporated into this application by reference.

### BACKGROUND OF THE INVENTION

(1) Field of the Invention

The present invention relates to a liquid crystal display device where the chromaticity is prevented from changing due to the gradation of the brightness.

(2) Related Art Statement

Liquid crystal display devices are formed of a liquid crystal display panel where a liquid crystal layer is sandwiched between a TFT substrate on which pixel electrodes and thin film transistors (TFT's) are formed in a matrix and a color filter substrate on which color filters and the like are formed. Liquid crystal molecules are controlled by video signals supplied to the respective pixel electrodes so that the light from the backlight and the like is controlled, and thus, an image is formed. In addition, color filters corresponding to the respective pixel electrodes are installed on the color filter substrate, and thus, a color image is formed.

The gradation of the brightness is established by setting the voltage to be applied to the liquid crystal for each gradation. The brightness of each color is determined by the degree of color temperature in which white light is set. However, the relationship between the voltage and the brightness differs for each color due to the transmission properties of the color filters. Thus, a phenomenon occurs where the color tone differs depending on the brightness. “Patent Document 1,” “Patent Document 2,” and the like can be cited as documents describing measures against such a phenomenon where the color tone differs depending on the brightness.

Display devices include an impulse response type and a hold response type, and liquid crystal display devices are categorized into hold response type displays. Hold response type displays are characterized in that a good display quality without flickering can be achieved in the case of a still image, but the periphery of a moving object blurs in the case of an animated image, that is to say, a so-called blurring of an animated image occurs, and thus, such a problem arises that the display quality deteriorates. The cause of the occurrence of this blurring of an animated image is a so-called after image on the retina where images displayed before and after the movement are interpreted by the observer for an image of which the brightness is held when the line of sight is shifted as the object moves, and therefore, the blurring in an animated image cannot be completely eliminated no matter how much the response rate of the display is increased.

As for a technique for solving this, there is an effective method according to which a black frame or the like is inserted so that the after image on the retina is once cancelled and the display is made closer to an impulse response type. “Patent Document 3” can be cited as a document which discloses the insertion of a black frame in this manner.

(Patent Document 1) Japanese Unexamined Patent Publication 2003-248467 (Corresponding U.S. patent U.S. Pat. No. 7,110,001)

(Patent Document 2) Japanese Unexamined Patent Publication 2004-212981 (Corresponding U.S. Application US2004/0125063 A1)

(Patent Document 3) Japanese Unexamined Patent Publication 2003-280599 (Corresponding U.S. patent U.S. Pat. No. 7,027,018)

### SUMMARY OF THE INVENTION

### (Problem to Be Solved by the Invention)

Such a problem arises with the insertion of a black frame according to a method for improving the properties of an animated image in a liquid crystal display device that the brightness of the screen is lowered. As an improved technique for inserting a black frame, there is a technique for inserting a black frame while preventing the brightness from lowering by forming one frame from two fields, a dark field and a bright field.

That is a method for preparing two field memories so that the image data for the two fields is written in the liquid crystal display with the frequency two times higher than the input signal, and thus, forming one frame image with the two fields.

According to this method, one frame is formed of two fields, a bright field and a dark field, and therefore, the relationship between the gradation and the brightness or the relationship between the gradation and the chromaticity is greatly different from a conventional method for operation. In the conventional systems where one frame is formed of two fields, a bright field and a dark field, the chromaticity changes in a range where the gradation is high, that is to say, in a region where the screen is bright.

An object of the present invention is to prevent the chromaticity from changing due to the gradation in driving a liquid crystal display device where one frame is formed of two fields, a bright field and a dark field, in order to improve the properties of an animated image.

### (Means for Solving Problem)

In order to achieve the above described object, the present invention provides a drive system having a measure against the blurring of an animated image by forming one frame from two fields, a bright field and a dark field, where the chromaticity can be prevented from changing by adjusting the relationship between the gradation and the voltage for each field or for each region of gradation, and in addition, for each color. In addition, the chromaticity can be prevented from changing without greatly changing the y properties, which are the relationship between the gradation and the brightness, by adjusting the gradation of the color, which is particularly effective for correction. Concrete means are as follows.

(1) A liquid crystal display device, where one frame is divided into two fields so that when the liquid crystal display device is driven, a first field displays the gradation between zero gradation and gradation T1 and a second field displays the gradation which exceeds the gradation T1, making a color display of red, green and blue possible, characterized in that the relationship between the gradation and the voltage in the above described first field is the same for red, green and blue and the relationship between the gradation and the voltage in the above described second field for one color from among red, green and blue is different from the relationship between the gradation and the voltage for the other two colors.

(2) The liquid crystal display device according to (1), characterized in that the above described one color is blue.

(3) A liquid crystal display device, where one frame is divided into two fields so that when the liquid crystal display device is driven, a first field displays the gradation between zero gradation and gradation T1 and a second field displays the gradation which exceeds the gradation T1, making a color display of red, green and blue possible, characterized in that the relationship between the gradation and the voltage in the above described first field is the same for red, green and blue and the relationship between the gradation and the voltage in the above described second field for one color from among red, green and blue is different from the relationship between the gradation and the voltage for the other two colors, and thus, the clarity value x and the clarity value y for white in the above described second field are reduced.

(4) The liquid crystal display device according to (3), characterized in that the above described one color is blue.

(5) A liquid crystal display device, where one frame is divided into two fields so that when the liquid crystal display device is driven, a first field displays the gradation between zero gradation and gradation T1 and a second field displays the gradation which exceeds the gradation T1, making a color display of red, green and blue possible, characterized in that a table indicating the gradation and the brightness in the above described first field is the same for red, green and blue and a table indicating the gradation and the brightness in the above described second field is the same for red, green and blue, while one color from among red, green and blue refers to a different value from the other two colors for the same gradation.

(6) The liquid crystal display device according to (5), characterized in that the above described one color is blue.

(7) A liquid crystal display device, where one frame is divided into two fields so that when the liquid crystal display device is driven, a first field displays the gradation between zero gradation and gradation T1 and a second field displays the gradation which exceeds the gradation T1, making a color display of red, green and blue possible, characterized in that when the above described first field is divided into gradation between the gradation zero and the gradation T2 and gradation between the gradation which exceeds T2 and the gradation T1, the relationship between the gradation between the gradation zero and the gradation T2 and the voltage in the above described first field is the same for red, green and blue, and the relationship between the gradation between the gradation which exceeds T2 and the gradation T1 and the voltage in the above described first field for one color from among red, green and blue is different from the relationship between the gradation and the voltage for the other two colors, and the relationship between the gradation and the voltage in the above described second field for one color from among red, green and blue is different from the relationship between the gradation and the voltage for the other two colors.

(8) The liquid crystal display device according to (7), characterized in that the above described one color is blue.

(9) A liquid crystal display device, where one frame is divided into two fields so that when the liquid crystal display device is driven, a first field displays the gradation between zero gradation and gradation T1 and a second field displays the gradation which exceeds the gradation T1, making a color display of red, green and blue possible, characterized in that when the above described first field is divided into gradation between the gradation zero and the gradation T2 and gradation between the gradation which exceeds T2 and the gradation T1, the relationship between the gradation between the gradation zero and the gradation T2 and the voltage in the above described first field is the same for red, green and blue, and the relationship between the gradation between the gradation which exceeds T2 and the gradation T1 and the voltage in the above described first field for one color from among red, green and blue is different from the relationship between the gradation and the voltage for the other two colors, and thus, the chromaticity value x and the chromaticity value y for white are increased, and the relationship between the gradation and the voltage in the above described second field for one color from among red, green and blue is different from the relationship between the gradation and the voltage for the other two colors, and thus, the chromaticity value x and the chromaticity value y for white are reduced.

(10) The liquid crystal display device according to (9), characterized in that the above described one color is blue.

(11) A liquid crystal display device, where one frame is divided into two fields so that when the liquid crystal display device is driven, a first field displays the gradation between zero gradation and gradation T1 and a second field displays the gradation which exceeds the gradation T1, making a color display of red, green and blue possible, characterized in that when the above described first field is divided into gradation between the gradation zero and the gradation T2 and gradation between the gradation which exceeds T2 and the gradation T1, a table indicating the gradation between the gradation zero and the gradation T2 and the brightness in the above described first field is the same for red, green and blue, and a table indicating the gradation between the gradation which exceeds T2 and the gradation T1 and the brightness in the above described first field is the same for red, green and blue, and one color from among red, green and blue refers to a different value from the other two colors, and a table indicating the gradation and the brightness in the above described second field is the same for red, green and blue, and one color from among red, green and blue refers to a different value from the other two colors.

(12) The liquid crystal display device according to (11), characterized in that the above described one color is blue.

(13) The liquid crystal display device according to (11), characterized in that the table indicating the gradation between the gradation which exceeds T2 and the gradation T1 and the brightness in the above described first field is the same for red, green and blue, and one color from among red, green and blue refers to a different value from the other two colors for the same gradation, and thus, the chromaticity value x and the chromaticity value y for white between the gradation which exceeds T2 and the gradation T1 are increased, and a table indicating the gradation and the brightness in the above described second field is the same for red, green and blue, and one color from among red, green and blue refers to a different value from the other two colors, and thus, the chromaticity value x and the chromaticity value y for white in the above described second field are reduced.

### EFFECTS OF THE INVENTION

According to the present invention, the chromaticity only in the dark field where the chromaticity changes drastically is corrected in the drive system where one frame of formed of a bright field and a dark field, and therefore, the scale of the correction can be reduced in comparison with the case where the bright field and the dark field are both corrected, and the manufacturing cost can be reduced accordingly.

In addition, in the case where only the dark field is corrected, only one color having a small change in the brightness at that time is corrected so that the brightness can be prevented from changing as a result of the correction of the chromaticity. In addition, only one color is corrected, and therefore, the scale of the correction can be further reduced.

According to another aspect of the present invention, the chromaticity is corrected for the gradation of a certain region in the bright field in addition to the correction of the chromaticity in the dark field, and thus, a more complete correction of the chromaticity becomes possible. In this case, the direction in which the dark field is corrected and the direction in which the chromaticity of a certain region in the bright field is corrected are different. In this manner, according to the present invention, the entirety of the bright field is not corrected even in the case where the bright field is corrected, but rather only a portion of the region in the bright field is corrected, and therefore, the scale of the correction can be reduced.

In this case as well, only the color which is especially effective for the correction is corrected, and thus, the scale of the correction can be further reduced. In addition, the brightness can be prevented from changing as a result of the correction of the chromaticity.

As described above, according to the present invention, the chromaticity can be prevented from changing due to the gradation while preventing the brightness from changing. In addition, according to the present invention, the correction of the gradation for correcting the chromaticity is on a small scale, and therefore, the manufacturing cost of the liquid crystal display device can be prevented from increasing.

### BRIEF DESCRIPTION OF THE DRAWINGS

FIG. 1 shows the configuration of a liquid crystal display device;

FIG. 2 shows the gradation-brightness properties in the FBI drive;

FIG. 3 shows the relationship between the gradation and the chromaticity value x;

FIG. 4 shows the relationship between the gradation and the chromaticity value y;

FIG. 5 shows the relationship between the gradation and the chromaticity value x in the FBI drive;

FIG. 6 shows the relationship between the gradation and the chromaticity value y in the FBI drive;

FIG. 7 shows a change in the brightness in the case where the chromaticity of white is changed by red;

FIG. 8 shows a change in the brightness in the case where the chromaticity of white is changed by green;

FIG. 9 shows a change in the brightness in the case where the chromaticity of white is changed by blue;

FIG. 10 shows a change in the chromaticity in the case where the gradation of red is changed;

FIG. 11 shows a change in the chromaticity in the case where the gradation of green is changed;

FIG. 12 shows a change in the chromaticity in the case where the gradation of blue is changed;

FIG. 13 is a table comparing the change in the gradation of each color and the effects of the change in the chromaticity;

FIG. 14 shows the chromaticity value x after correction;

FIG. 15 shows the chromaticity value y after correction;

FIG. 16 shows a comparison before and after the correction of the chromaticity value x;

FIG. 17 shows a comparison before and after the correction of the chromaticity value y;

FIG. 18 shows an example of the correction of the gradation; and

FIG. 19 shows the y properties before and after the correction of the chromaticity.

### EXPLANATION OF SYMBOLS

101 . . . input display data
102 . . . control signal group
103 . . . drive selecting signal
104 . . . timing signal generating circuit
105 . . . memory control signal group
106 . . . table initializing signal
107 . . . data selecting signal
108 . . . data driver controlling signal group
109 . . . scanning driver control signal group
110 . . . frame memory
111 . . . memory read data
112 . . . ROM
113 . . . table data
114 . . . bright field converting table
115 . . . dark field converting table
116 . . . bright field display data
117 . . . dark field display data
118 . . . display data selecting circuit
119 . . . field display data
120 . . . gradation voltage generating circuit
121 . . . gradation voltage
122 . . . data driver
123 . . . data voltage
124 . . . scanning driver
125 . . . scanning line selecting signal
126 . . . liquid crystal display panel
127 . . . schematic diagram showing one pixel in liquid crystal display panel
128 . . . scanning line
129 . . . data signal line

### DETAILED DESCRIPTION OF THE INVENTION

### (Best Mode for Carrying Out the Invention)

The detailed contents of the present invention are disclosed in accordance with the embodiments.

### First Embodiment

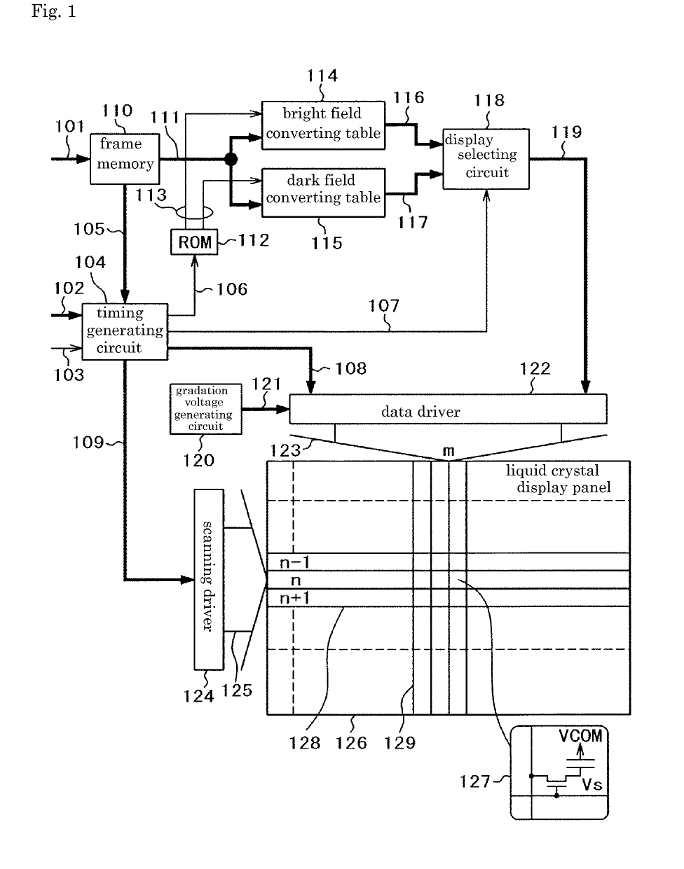

FIG. 1 is a diagram showing the configuration of a liquid crystal display device. The present device corresponds to a display for 256 gradations for each color, R, G and B, that is to say, a total of 16,770,000 colors. 101 indicates input display data formed of 8 bits for R, G and B, that is to say, a total of 24 bits, and 102 indicates an input signal group. The input signal group 102 is formed of a vertical sync signal Vsync for defining one frame period (period for displaying one screen), a horizontal sync signal Hsync for defining one horizontal period (period for displaying one sentence line), a display timing signal DISP for defining the effective period of display data, and a reference clock signal DCLK which is in sync with the display data.

103 indicates a drive selecting signal. On the basis of this drive selecting signal 103, a conventional drive system or a drive system where the blurring in the animated image is reduced is selected. The input display data 101, the input signal group 102 and the drive selecting signal 103 are transferred from an external system (for example, a TV main body, a PV main body or a cellular phone main body).

104 indicates a timing signal generating circuit, 105 indicates a memory control signal group, 106 indicates a table initializing signal, 107 indicates a data selecting signal, 108 indicates a data driver control signal group and 109 indicates a scanning driver control signal group. The data driver control signal group 108 is formed of an output signal CL1 for defining the timing according to which the gradation voltage is outputted on the basis of the display data, an alternating signal M for determining the polarity of the source voltage and a clock signal PCLK which is in sync with the display data, while the scanning driver control signal group 109 is formed of a shift signal CL3 for defining the scanning period of one line and a vertical start signal FLM for defining the start of the scanning of the leading line.

110 indicates a frame memory having at least the capacitance for one frame of the display data which carries out a reading and writing process on the display data on the basis of the memory signal group 105. 111 indicates memory read data read out from the frame memory 110 on the basis of the memory control signal group 105, 112 indicates a ROM (read only memory) for outputting data stored inside on the basis of the table initializing signal, 113 indicates table data outputted from the ROM, 114 indicates a first field converting table, 115 indicates a second field converting table and 116 indicates a third field converting table.

The value of each table is set on the basis of the table data 113 when the power is turned on, and the memory read data 111 that has been read out is converted on the basis of the values set in the respective tables. The bright field converting table 114 has a function for the data converting circuit for the bright field, and the dark field converting table 115 has a function for the data converting circuit for the dark field.

116 indicates bright field display data that has been converted by the bright field converting table 114 and 117 indicates dark field display data that has been converted by the dark field converting table 115. 118 indicates a display data selecting circuit which selects and outputs either the bright field display data 116 or the dark field display data 117 on the basis of the data selecting signal 107. 119 indicates selected field display data.

120 indicates a gradation voltage generating circuit and 121 indicates a gradation voltage. 122 indicates a data driver, and the data driver 122 generates the potentials of 2⁸ (2 to the eighth power)=256 levels for the positive and negative polarities, that is to say, a total of 512 levels from the gradation voltage 121, and at the same time, selects a potential of one level corresponding to the field display data 119, which is 8 bits for each color, and the polarity signal M for each color so as to apply the selected potential to the liquid crystal display panel 126 as the data voltage.

123 indicates a data voltage generated by the data driver 122. 124 indicates a scanning driver and 125 indicates a scanning line selecting signal. The scanning driver 124 generates a scanning line selecting signal 125 on the basis of the scanning driver control signal group 109 and outputs the generated signal to the scanning line of the liquid crystal display panel.

126 indicates a liquid crystal display panel, and 127 is a schematic diagram showing one pixel of the liquid crystal display pane 126. The pixel 127 is formed in a region surrounded by two scanning lines 128 and two data signal lines 129. One pixel of the liquid crystal panel 126 is formed of a TFT (thin film transistor), made up of a source electrode, a gate electrode and a drain electrode, a liquid crystal layer and a counter electrode. A switching operation of the TFT is carried out when a scanning signal is applied to the gate electrode where the data voltage is written into the source electrode connected to one side of the liquid crystal layer via the drain electrode when the TFT is in an open state while the voltage written into the source electrode is maintained in a closed state. The voltage of the source electrode is the same as the voltage of the transparent electrode ITO, which is a pixel electrode for actually driving the liquid crystal layer. The voltage of this pixel electrode is Vp, and the counter electrode voltage is Vcom. The liquid crystal layer changes the direction of the polarity on the basis of the potential difference between the pixel electrode voltage Vp and the counter electrode voltage Vcom, and at the same time, the amount of transmission light from the backlight provided on the rear surface changes via the polarizing plates provided on the top and the bottom of the liquid crystal layer so as to provide a gradation display.

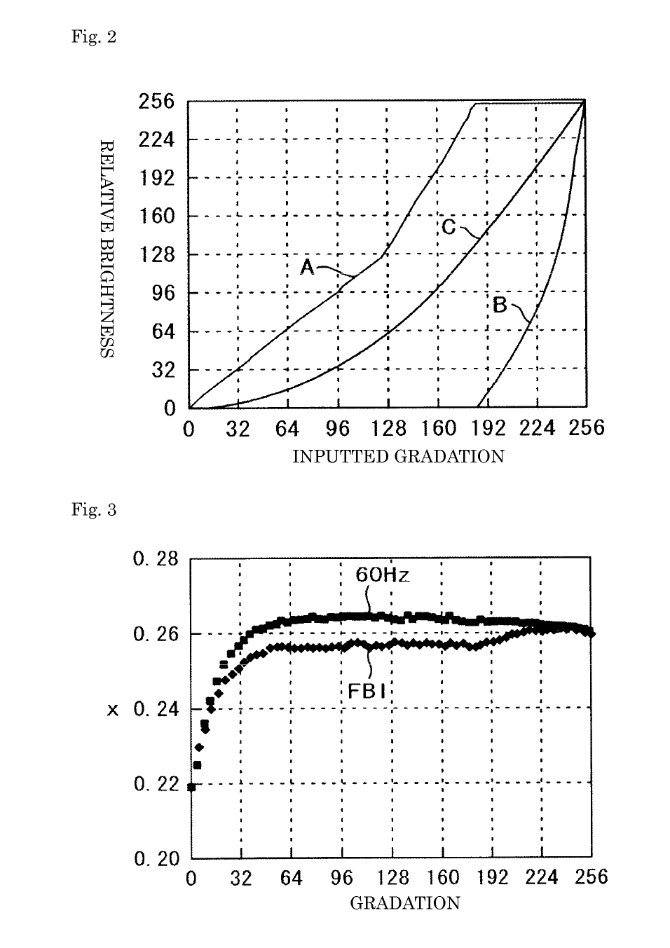

FIG. 2 shows the relationship between the gradation and the brightness in the two fields. FIG. 2 shows the gray scale of 256 gradations. In FIG. 2, the longitudinal axis indicates the relative brightness and the lateral axis indicates the gradation. In FIG. 2, the curve A indicates the gradation-brightness properties in the first field and the curve B indicates the gradation-brightness properties in the second field. In addition, the curve C indicates the gradation-brightness properties of an image to be displayed.

The first field is responsible for the case of the brightness where the gradation is 190 or lower. In the case where the brightness has a gradation of 190 or lower, the output from the second field may be zero. That is to say, in the case where the brightness of the image is 190 or lower in the gradation, black can be applied without the brightness being lowered.

In the case where the gradation exceeds 190, for example, in the case where the gradation shown in FIG. 2 is 200, image data can also be outputted from the second field, but the brightness is low in comparison with the first field, and therefore, the blurring of the animated image can be reduced.

Here, in the present specification, the first field always displays an image irrespective of the brightness of the image, and therefore, is referred to as bright field. The second field displays an image for the first time when the gradation of the image exceeds 190, and therefore, is usually a dark field and referred to as dark field.

As described above, though a method for forming one frame of a bright field and a dark field (hereinafter referred to as FBI (flexible black data insertion)) is an excellent method in that the same effects as the application of black can be gained without the brightness being lowered, such a problem arises that the relationship between the gradation and the chromaticity greatly differs between the bright field and the dark field.

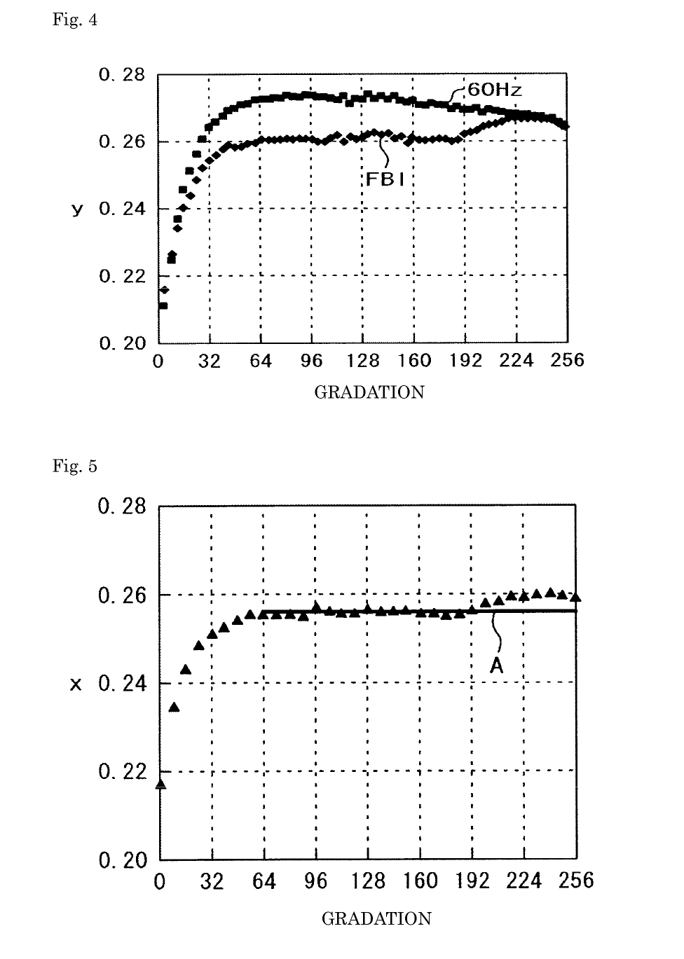

FIGS. 3 and 4 are graphs where changes in the chromaticity in the case where white is displayed for each gradation are plotted. FIGS. 3 and 4 show changes in the chromaticity in both a conventional drive method (indicated as 60 Hz in FIGS. 3 and 4) and the FBI drive method. In addition, in FIGS. 3 and 4 the same conversion table is for the relationship between the gradation and the voltage for red, green and blue.

FIG. 3 shows a change in the y coordinate for each gradation in the chromaticity coordinates. In FIG. 3, the lateral axis indicates gradation and the longitudinal axis indicates the x coordinate. In FIG. 3, the 60 Hz drive indicates flat properties in a relatively wide range, while a drastic change can be observed in the vicinity of the gradation 180 in the FBI drive. That is to say, the FBI drive has a great change in the chromaticity in the dark field.

FIG. 4 shows a change in the y coordinate for each gradation in the chromaticity coordinates. In FIG. 4, the lateral axis indicates gradation and the longitudinal axis indicates the y coordinate. In FIG. 4, in the 60 Hz drive, the chromaticity value y indicates slightly protruding properties without a drastic change, and thus, indicates flat properties in a relatively wide range. In the FBI drive, however, a drastic change is observed in the vicinity of the gradation 190. That is to say, as for the chromaticity value y in the FBI drive, the chromaticity changes greatly in the dark field. In any case, in the FBI drive, the change in the chromaticity in a conventional 60 Hz drive is different.

In FIG. 5, line A shows the ideal value where the chromaticity value does not change as opposed to the measured values of the chromaticity value x in the case of the FBI drive. It can be seen in FIG. 5 that the value x starts shifting upwards from the ideal value in the vicinity of the gradation 190.

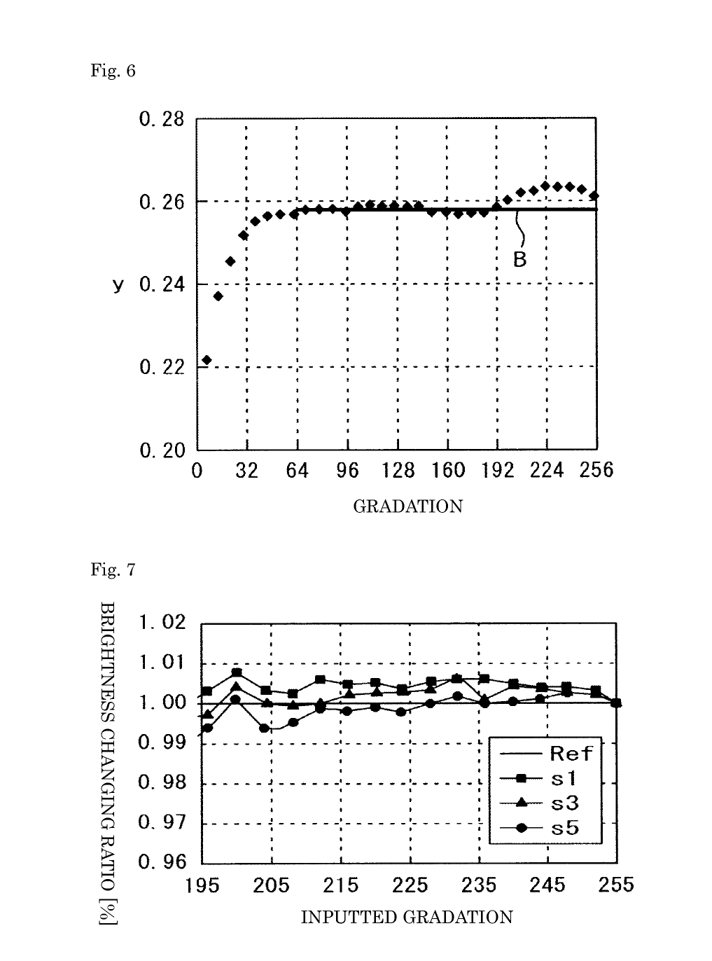

In FIG. 6, line B shows the ideal value where the chromaticity value does not change as opposed to the measured values of the chromaticity value y in the case of the FBI drive. It can be seen from FIG. 6 that the value y starts shifting upwards from the ideal value in the vicinity of the gradation 190.

As can be seen from FIGS. 5 and 6, the numerical values of both the value x and the value y are greater than the ideal values in the dark field. Accordingly, a change in the chromaticity for the entirety of the image can be reduced in the case where such a correction is carried out in the dark field that both the value x and the value y are reduced.

In the case where the chromaticity is changed, the gradation is changed, and together with this, the brightness is also changed. However, it is necessary to keep the change in the brightness as small as possible. In order to change the chromaticity, it is necessary to change the relationship between the gradation and the voltage applied to the pixels for each color, that is to say, to carry out correction. Meanwhile, the chromaticity of white can be changed by changing one color from among the respective colors.

FIGS. 7 to 9 show evaluations for red, green and blue in terms of the degree of change in the brightness in accordance with the amount of correction in the chromaticity in the case where the chromaticity is corrected for each color. In FIGS. 7 to 9, s1, s2 and s3 indicate the amounts of correction in the chromaticity.

FIG. 7 shows to which extent the brightness changes in the case where it is attempted that the chromaticity becomes constant by changing the gradation of red. In FIG. 7, the lateral axis indicates input gradation and the longitudinal axis indicates the brightness changing ratio. s1, s3 and s5 indicate the amounts of chromaticity that are to be changed. In addition, Ref indicates a case where there is no change in the brightness even when the chromaticity is changed.

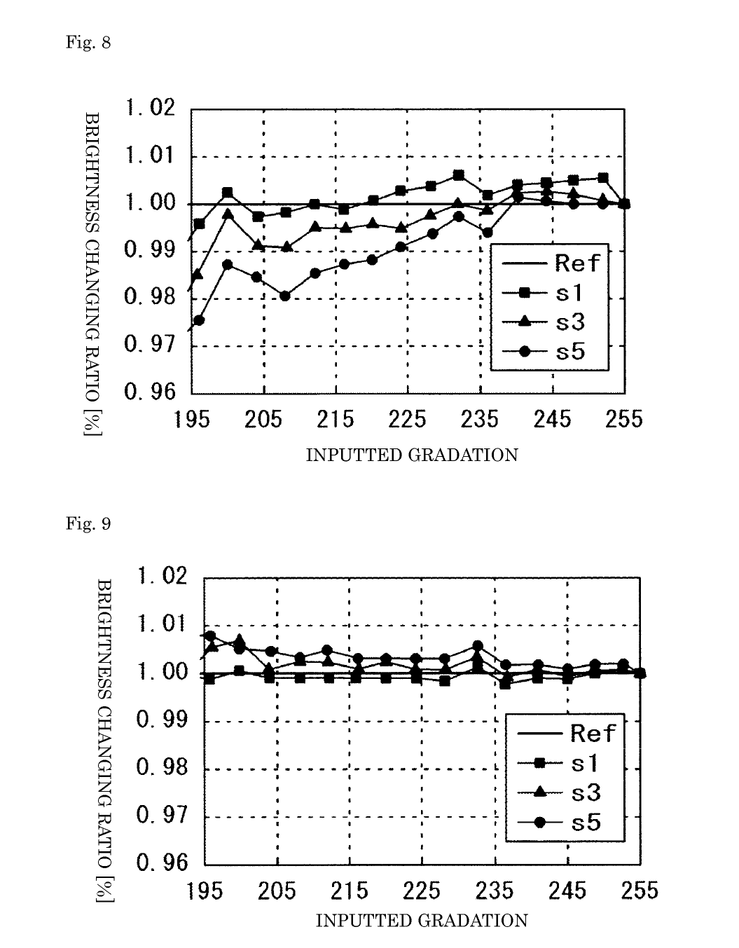

FIG. 8 shows to which extent the brightness changes in the case where it is attempted that the chromaticity becomes constant by changing the gradation of green. In FIG. 8, the lateral axis indicates input gradation and the longitudinal axis indicates the brightness changing ratio. s1, s3, s5 and Ref are the same as in FIG. 7.

FIG. 9 shows to which extent the brightness changes in the case where it is attempted that the chromaticity becomes constant by changing the gradation of blue. In FIG. 9, the lateral axis indicates input gradation and the longitudinal axis indicates the brightness changing ratio. s1, s3, s5 and Ref are the same as in FIG. 7.

It can be seen from the comparison of FIGS. 7 to 9 that the change in the brightness becomes the smallest in the case of blue when the chromaticity is changed by a certain amount for each gradation.

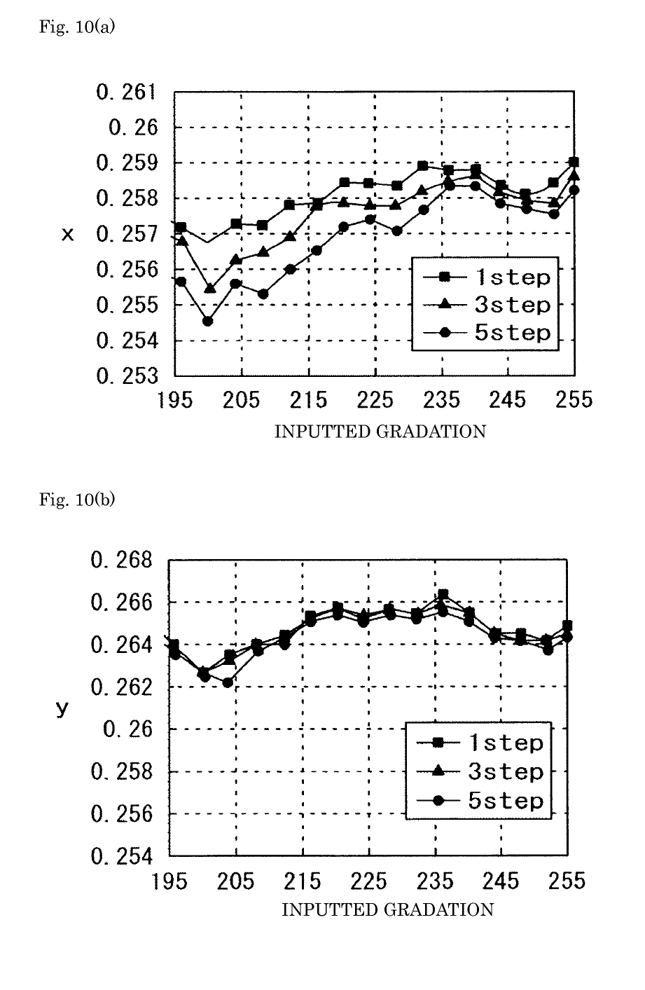

Meanwhile, FIGS. 10 to 12 show how the chromaticity changes in the case where the respective gradations for red, green and blue are changed in order to change the chromaticity. It can be said that the efficiency for correction is high in the case where the chromaticity greatly changes together with the change in the gradation. That is to say, the chromaticity can be adjusted through the correction of a few gradations.

FIG. 10 shows the evaluation to which extent the chromaticity changes in the case where the gradation is corrected for red. In FIG. 10, 1step, 2step and 3step indicate the differences in the amount of correction. FIG. 10(a) shows the evaluation to which extent the chromaticity value x changes in the case where the gradation is corrected for red, and FIG. 10(b) shows the evaluation to which extent the chromaticity value y is changed in the case where red is corrected. As can be seen from FIGS. 10(a) and 10(b), the correction of red can change the chromaticity value x efficiently.

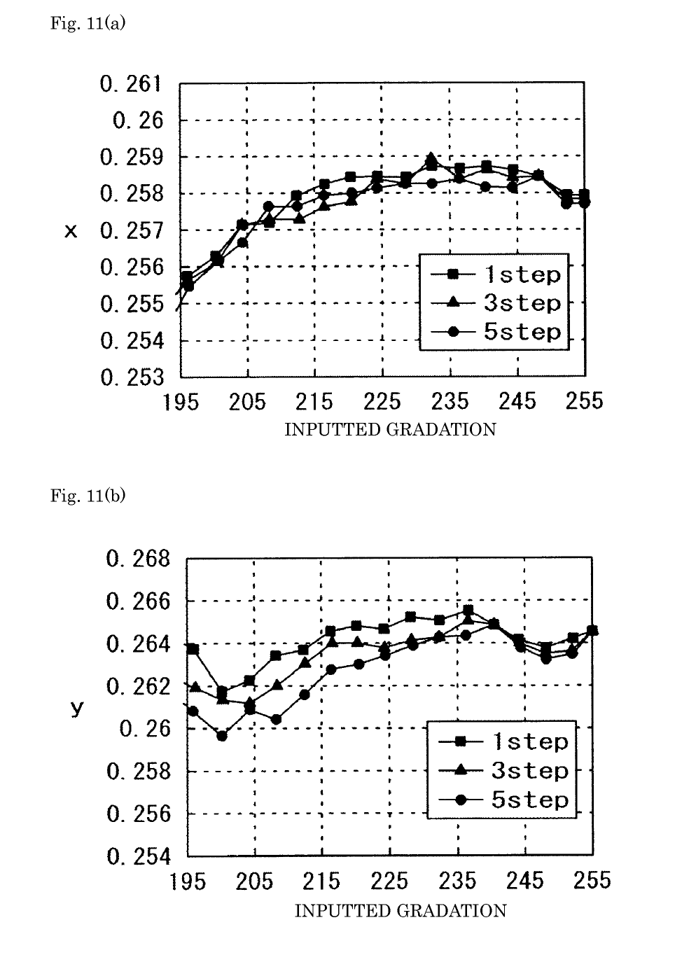

FIG. 11 shows the evaluation to which extent the chromaticity changes in the case where the gradation is corrected for green. In FIG. 11, 1step, 2step and 3step indicate the differences in the amount of correction. FIG. 11(a) shows the evaluation to which extent the chromaticity value x changes in the case where the gradation is corrected for green, and FIG. 11(b) shows the evaluation to which extent the chromaticity value y is changed in the case where green is corrected. As can be seen from FIGS. 11(a) and 11(b), the correction of green can change the chromaticity value y efficiently.

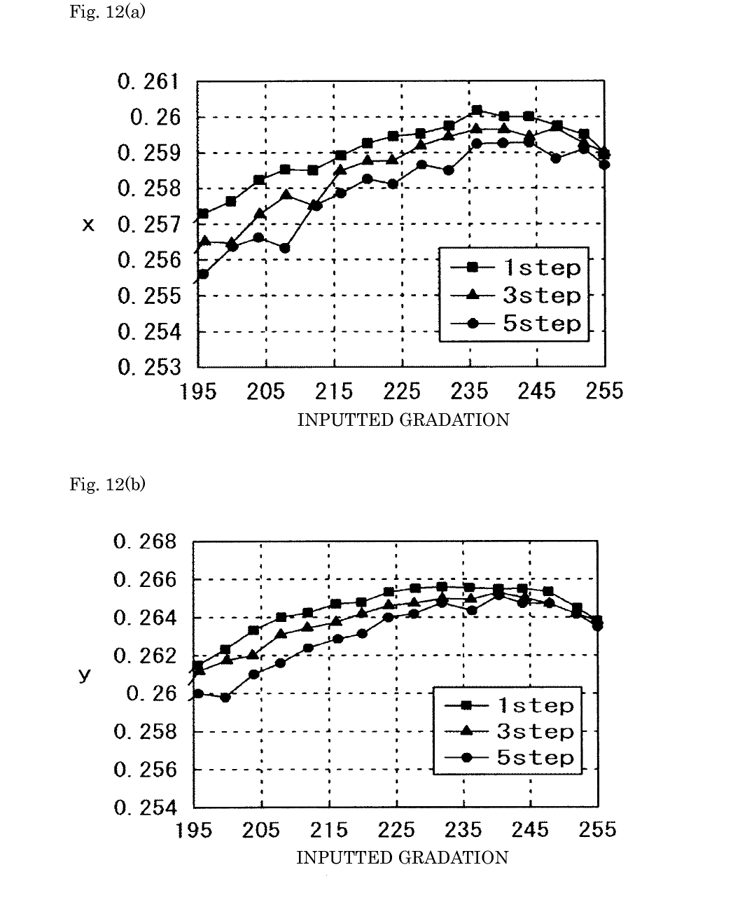

FIG. 12 shows the evaluation to which extent the chromaticity changes in the case where the gradation is corrected for blue. In FIG. 12, 1step, 2step and 3step indicate the differences in the amount of correction. FIG. 12(a) shows the evaluation to which extent the chromaticity value x changes in the case where the gradation is corrected for blue, and FIG. 12(b) shows the evaluation to which extent the chromaticity value y is changed in the case where blue is corrected. As can be seen from FIGS. 12(a) and 12(b), the correction of blue can change both the chromaticity values x and y efficiently.

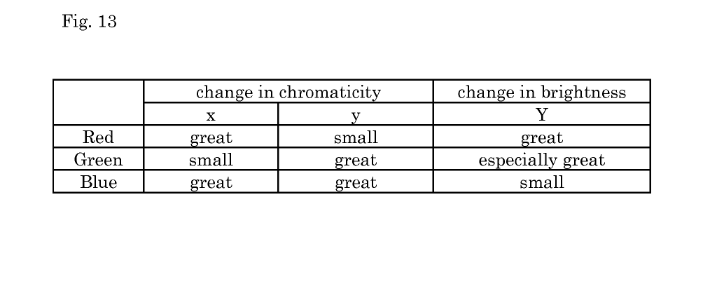

In the table shown in FIG. 13, the evaluations from FIGS. 7 to 12 are summarized. As can be seen from the table, the effects are gained only for the chromaticity value x with a great change in the brightness in the case where the gradation of red is corrected. In addition, the effects are gained only for the chromaticity value y with a very great change in the brightness in the case where the gradation of green is corrected. The effects are gained for both the chromaticity values x and y with a very small change in the brightness in the case where the gradation of blue is corrected. As a result of this, it is most efficient to correct the gradation table for blue in order to make the change in the chromaticity small and the change in the brightness small.

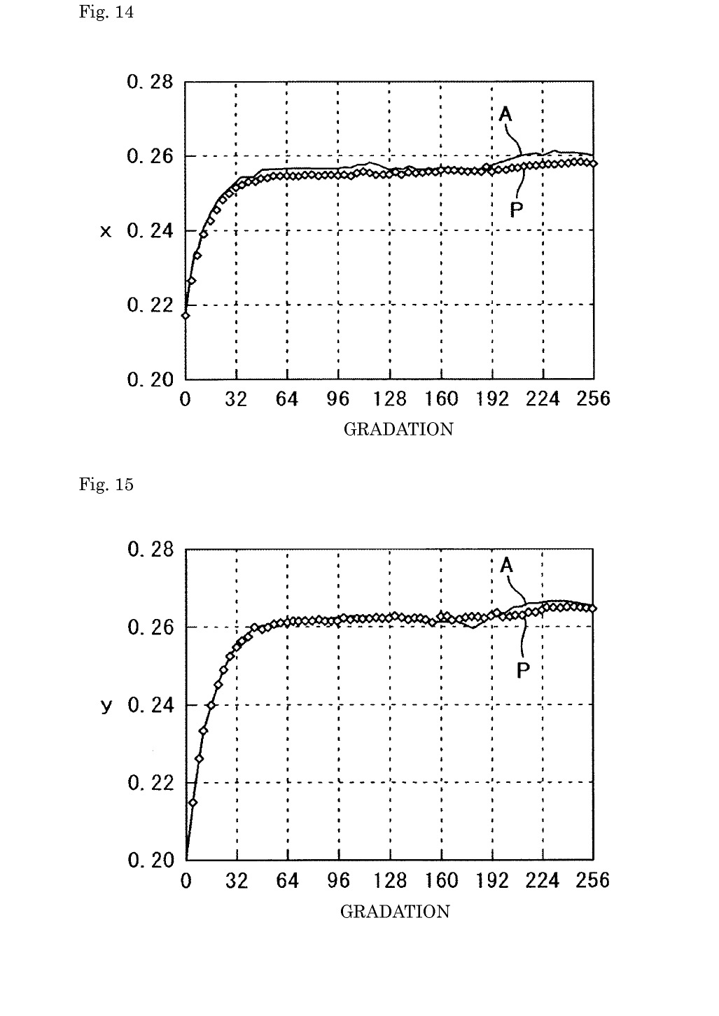

FIGS. 14 and 15 show the evaluation of the change in the chromaticity in the case where the gradation for blue is changed in the dark field in the above described manner. FIG. 14 shows the change in the chromaticity value x. In FIG. 14, the curve A indicates the change in the chromaticity before correction and the diamond-shaped plots P indicate the change in the chromaticity after correction. When the results P gained by plotting the measured values after correction and the values indicated by the curve A before correction are compared, the change in the chromaticity value x after correction is small and smooth.

In the same manner, FIG. 15 shows the change in the chromaticity value y. In FIG. 15, the curve A indicates the change in the chromaticity before correction and the diamond-shaped plots P indicate the change in the chromaticity after correction. In FIG. 15, when the results P gained by plotting the measured values after correction and the values indicated by the curve A before correction are compared, the change in the chromaticity value y after correction is small and smooth.

The above described results in the present embodiment are summarized as follows. That is to say, in the FBI, the change in the chromaticity is great in the dark field. As shown in FIG. 1, the FBI has a bright field converting table and a dark field converting table so that the gradation and the voltage applied to the pixel electrodes can be determined by referring to these tables.

Judging from the results of the present embodiment, in the FBI drive, the same gradation table can be used for red, green and blue in the bright field, and the same gradation table can be used for red and green while using the corrected gradation field only for blue in the dark field. In the case where a bright field and a dark field are provided for red, green and blue, respectively, six tables become necessary. In comparison to this, in the present invention, only three tables are provided, and the system is greatly simplified.

Meanwhile, even in the case where the gradation is changed for red, green and blue, respectively, in order to correct the chromaticity with higher resolution in the dark field, only four tables are necessary, and still such effects can be gained that the system is simplified.

### Second Embodiment

According to the first embodiment, the change in the chromaticity is reduced by a great degree. Meanwhile, in reference to FIGS. 5 and 6, in the FBI drive according to the prior art, the chromaticity has a value smaller than the ideal value indicated by lines A and B in a range from the vicinity of the gradation 150 to the vicinity of the gradation 190 in the bright field. It is desirable to make the values in this range close to the ideal value in order to make the change in the chromaticity inconspicuous.

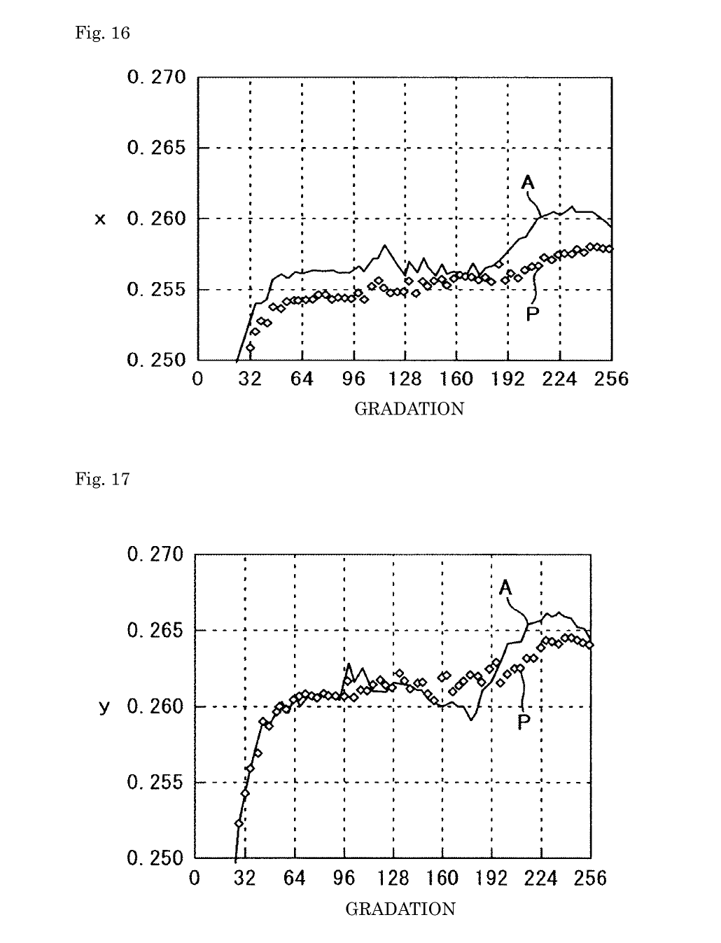

FIGS. 16 and 17 are graphs showing the change in the chromaticity values x and y more greatly by changing the scale of the longitudinal axis. In FIGS. 16 and 17, the curve A indicates the change in the chromaticity before correction. In addition, in FIGS. 16 and 17, the diamond-shaped plots P indicate the change in the chromaticity after the below described correction. The change in the chromaticity after correction is small, and the manner of the change is smooth.

As can be seen from FIG. 17, the chromaticity value y goes downwards from the gradation 150 to the gradation 190. Meanwhile, as shown in FIG. 16, the chromaticity value x does not change greatly from the gradation 150 to the gradation 190. Accordingly, the gradation may be corrected so that the chromaticity value y increases in a range from the gradation 150 to the gradation 190 in the bright field.

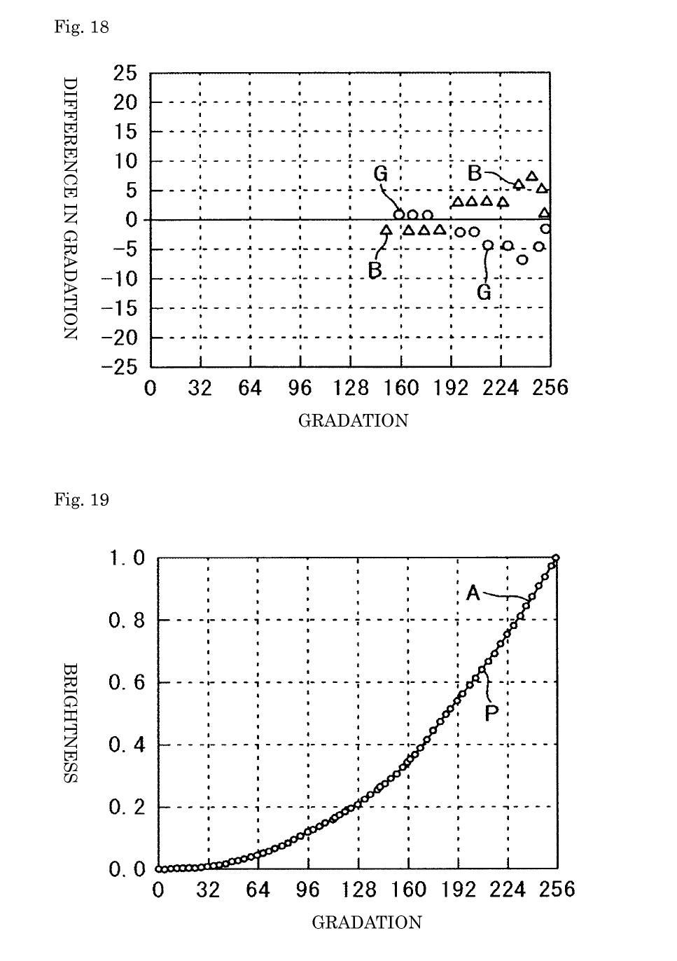

FIG. 18 shows one example of the correction of the gradation. In FIG. 18, the lateral axis indicates the gradation. The longitudinal axis indicates how many gradations are before the corrected gradation when the gradation is referred to. That is to say, in the case where the longitudinal axis indicates −1, the gradation is referred to which is one lower than the gradation initially referred to.

In FIG. 18, the value of the gradation which is one lower is referred to for blue from the gradation 150 to the gradation 190, while the value of the gradation which is one above is referred to for green. In addition, the value of the gradation which is two to six above is referred to for blue, depending on the gradation in the dark field. In addition, the value of the gradation which is one to six lower is referred to for green.

The change in the chromaticity as a result of the above described correction is indicated by the plots P in FIGS. 16 and 17. As shown in FIGS. 16 and 17, the change in the chromaticity is greatly reduced according to the method for correction shown in FIG. 18.

According to the manner of correction in FIG. 18, basically the same gradation table is used for red, green and blue, and a different value of gradation from the original gradation may be referred to only for the gradation where the correction of the chromaticity is required and only for a necessary color. Therefore, according to the present invention, it is possible to greatly simplify the system in comparison with the case where a table is provided for red, green and blue, respectively, in the bright field and the dark field. The correction in FIG. 18 is one example, and it is not necessary to limit the gradation correction according to the present invention to the method in FIG. 18.

FIG. 19 shows the y properties after the chromaticity value has been corrected according to the present invention. In FIG. 19, the lateral axis indicates the gradation and the longitudinal axis indicates the brightness. The y properties after correction are white circular plots P. The curve A indicates the y properties before correction, and the y properties completely coincide before and after correction. Therefore, according to the present invention, the change in the chromaticity can be kept small, and at the same time, the change in the brightness, that is to say, the change in the y properties can also be prevented.

1. A liquid crystal display device, where one frame is divided into two fields so that when the liquid crystal display device is driven, a first field displays the gradation between zero gradation and gradation T1 and a second field displays the gradation which exceeds the gradation T1, making a color display of red, green and blue possible, characterized in that
the relationship between the gradation and the voltage in said first field is the same for red, green and blue and the relationship between the gradation and the voltage in said second field for one color from among red, green and blue is different from the relationship between the gradation and the voltage for the other two colors.

2. The liquid crystal display device according to claim 1, characterized in that said one color is blue.

3. A liquid crystal display device, where one frame is divided into two fields so that when the liquid crystal display device is driven, a first field displays the gradation between zero gradation and gradation T1 and a second field displays the gradation which exceeds the gradation T1, making a color display of red, green and blue possible, characterized in that
the relationship between the gradation and the voltage in said first field is the same for red, green and blue and the relationship between the gradation and the voltage in said second field for one color from among red, green and blue is different from the relationship between the gradation and the voltage for the other two colors, and thus, the clarity value x and the clarity value y for white in said second field are reduced.

4. The liquid crystal display device according to claim 3, characterized in that said one color is blue.

5. A liquid crystal display device, where one frame is divided into two fields so that when the liquid crystal display device is driven, a first field displays the gradation between zero gradation and gradation T1 and a second field displays the gradation which exceeds the gradation T1, making a color display of red, green and blue possible, characterized in that
a table indicating the gradation and the brightness in said first field is the same for red, green and blue and a table indicating the gradation and the brightness in said second field is the same for red, green and blue, while one color from among red, green and blue refers to a different value from the other two colors for the same gradation.

6. The liquid crystal display device according to claim 5, characterized in that said one color is blue.

7. A liquid crystal display device, where one frame is divided into two fields so that when the liquid crystal display device is driven, a first field displays the gradation between zero gradation and gradation T1 and a second field displays the gradation which exceeds the gradation T1, making a color display of red, green and blue possible, characterized in that
when said first field is divided into gradation between the gradation zero and the gradation T2 and gradation between the gradation which exceeds T2 and the gradation T1, the relationship between the gradation between the gradation zero and the gradation T2 and the voltage in said first field is the same for red, green and blue, and the relationship between the gradation between the gradation which exceeds T2 and the gradation T1 and the voltage in said first field for one color from among red, green and blue is different from the relationship between the gradation and the voltage for the other two colors, and
the relationship between the gradation and the voltage in said second field for one color from among red, green and blue is different from the relationship between the gradation and the voltage for the other two colors.

8. The liquid crystal display device according to claim 7, characterized in that said one color is blue.

9. A liquid crystal display device, where one frame is divided into two fields so that when the liquid crystal display device is driven, a first field displays the gradation between zero gradation and gradation T1 and a second field displays the gradation which exceeds the gradation T1, making a color display of red, green and blue possible, characterized in that
when said first field is divided into gradation between the gradation zero and the gradation T2 and gradation between the gradation which exceeds T2 and the gradation T1, the relationship between the gradation between the gradation zero and the gradation T2 and the voltage in said first field is the same for red, green and blue, and the relationship between the gradation between the gradation which exceeds T2 and the gradation T1 and the voltage in said first field for one color from among red, green and blue is different from the relationship between the gradation and the voltage for the other two colors, and thus, the chromaticity value x and the chromaticity value y for white are increased, and
the relationship between the gradation and the voltage in said second field for one color from among red, green and blue is different from the relationship between the gradation and the voltage for the other two colors, and thus, the chromaticity value x and the chromaticity value y for white are reduced.

10. The liquid crystal display device according to claim 9, characterized in that said one color is blue.

11. A liquid crystal display device, where one frame is divided into two fields so that when the liquid crystal display device is driven, a first field displays the gradation between zero gradation and gradation T1 and a second field displays the gradation which exceeds the gradation T1, making a color display of red, green and blue possible, characterized in that
when said first field is divided into gradation between the gradation zero and the gradation T2 and gradation between the gradation which exceeds T2 and the gradation T1,
a table indicating the gradation between the gradation zero and the gradation T2 and the brightness in said first field is the same for red, green and blue, and a table indicating the gradation between the gradation which exceeds T2 and the gradation T1 and the brightness in said first field is the same for red, green and blue, and one color from among red, green and blue refers to a different value from the other two colors, and
a table indicating the gradation and the brightness in said second field is the same for red, green and blue, and one color from among red, green and blue refers to a different value from the other two colors.

12. The liquid crystal display device according to claim 11, characterized in that said one color is blue.

13. The liquid crystal display device according to claim 11, characterized in that
the table indicating the gradation between the gradation which exceeds T2 and the gradation T1 and the brightness in said first field is the same for red, green and blue, and one color from among red, green and blue refers to a different value from the other two colors for the same gradation, and thus, the chromaticity value x and the chromaticity value y for white between the gradation which exceeds T2 and the gradation T1 are increased, and
a table indicating the gradation and the brightness in said second field is the same for red, green and blue, and one color from among red, green and blue refers to a different value from the other two colors, and thus, the chromaticity value x and the chromaticity value y for white in the above described second field are reduced.
